(19) United States
(12) Patent Application Publication
(10) Pub. No.: US 2020/0024395 A1
(43) Pub. Date: Jan. 23, 2020

(54) SEMI-CRYSTALLINE POLYAMIDE COMPOSITION HAVING A HIGH GLASS TRANSITION TEMPERATURE AND A HIGH MELTING TEMPERATURE FOR A THERMOPLASTIC MATERIAL, PRODUCTION METHOD THEREOF AND USES OF SAME

(71) Applicant: Arkema France, Colombes (FR)

(72) Inventor: Mathieu CAPELOT, Bernay (FR)

(21) Appl. No.: 16/495,898

(22) PCT Filed: Mar. 23, 2018
(86) PCT No.: PCT/FR2018/050710

§ 371 Date: Sep. 20, 2019

(30) Foreign Application Priority Data
Mar. 24, 2017 (FR) 1752485

(51) Int. Cl. C08G 69/26; C08G 69/28; B29C 45/00

(52) U.S. Cl. CPC C08G 69/265; B29K 2077/00; B29C 45/0005; C08G 69/28

(57) ABSTRACT

The invention relates to a composition for a thermoplastic material comprising:
0 to 70% by weight, preferably 20 to 60% by weight, of short reinforcing fibers,
30 to 100% by weight, preferably 40 to 80% by weight, of a thermoplastic matrix based on at least one semi-crystalline polyamide polymer,
0 to 50% of additives and/or other polymers,
   where said semi-crystalline polyamide polymer is:
a) a reactive composition comprising or consisting of at least one reactive polyamide prepolymer precursor of said semi-crystalline polyamide polymer,
or in alternative to a),
b) a non-reactive composition of at least one polyamide polymer where said composition is that of said thermoplastic matrix defined above,
   and said reactive polyamide prepolymer for the composition a) and said polyamide polymer for the composition b) comprising or consisting of at least one BACT/XT copolyamide.

The invention relates to a new semi-crystalline (sc) polyamide composition with high glass transition temperature based on bis(aminoethyl)cyclohexane (BAC) for a thermoplastic material.

It also relates to the method of producing said thermoplastic material and also the uses of said composition for the production of mechanical or structural parts based on said material for material parts and also the part resulting therefrom and for application in the following fields: automobile, rail, marine, highway transport, wind, sport, aeronautics and spatial, construction, panels and leisure, and electrical and electronics.

A major challenge in materials is to find a polyamide resin meeting the following specifications:

High Tg over a wide service temperature range;

High Tm for good temperature resistance but sufficiently low for being processable in particular by injection;

A very good suitability for crystallization in order to be able to be unmolded quickly and thus be compatible with intensive production cycles, such as those used for example in the automobile industry;

A high stiffness, including when hot, in order to produce the highest possible moduli from the final material.

The document CN104211953 describes a polyamide composition comprising 30 to 99.9% by weight of a polyamide resin comprising from 60 to 95 mol % of 10T, from 5 to 40 mol % of 5′T, where 5′ corresponds to 2-methyl-1,5-pentamethylenediamine, from 0 to 70% by weight of a reinforcing filler and from 0.1 to 50% by weight of an additive.

The polyamide resin has a melting temperature over 260° C. and high molar proportions of 10T.

EP 550,314 describes, in its examples, (non-reactive) copolyamide compositions while targeting melting temperatures over 250° C. and limited Tg with most of the examples given having a Tg that is too low (<80° C.).

EP 1,988,113 describes a 10T/6T copolyamide-based molding composition with:

40 to 95 mol % of 10T

5 to 40% of 6T.

In particular, polyamides are sought with high 10T molar proportions and high melting temperature over 270° C.

WO 2011/003973 describes compositions comprising 50 to 95 mol % of a linear aliphatic diamine based motif comprising from 9 to 12 carbon atoms and terephthalic acid and 5 to 50% of a motif combining terephthalic acid with a mixture of 2,2,4- and 2,4,4-trimethylhexanediamine.

WO 2014/064375 in particular describes a MXDT/10T PA which has an excellent compromise between the various characteristics described above. Unfortunately, the meta-xylenediamine (MXD) monomer used is very susceptible to secondary reactions, giving rise in particular to the formation of branching.

The disadvantages of the state-of-the-art, with the absence of a good compromise between mechanical performance and suitability for implementation (ease of transformation) with a shorter production cycle time are overcome by the solution from the present invention which targets semi-crystalline PA compositions having an excellent compromise between high mechanical performance (mechanical strength) in particular when hot and easy implementation in particular by injection. It has in fact a high stiffness and has a glass transition temperature >150° C., Tm included between 290° C. and 340° C., and also an excellent ability to crystallize (Tm−Tc<40° C.), which makes it a choice matrix for implementation in particular by injection or molding, in particular for wind, automotive or aeronautics or for electrical and electronics.

The choice of a semi-crystalline polyamide polymer as matrix for the thermoplastic material from the invention is attractive compared to amorphous polyamides because of significantly improved mechanical performance in particular when hot, such as creep or fatigue resistance. Further, a melting point over 200° C. is advantageous in the automobile domain for compatibility with cataphoresis treatments, which an amorphous PA type structure does not allow. A Tg over 150° C. is sought for providing good mechanical properties for the thermoplastic material over the full temperature range of use, in particular for injection. The crystallinity of said polymer must be the highest possible for optimizing mechanical performance and the rate of crystallization and/or crystallization temperature as high as possible so as to reduce the molding time before injection of the molded part with a selective choice for the composition of said semi-crystalline polyamide.

The subject matter of the present invention is the implementation of specific new compositions of thermoplastic material, in particular based on a semi-crystalline polyamide having a good compromise between high mechanical performance (mechanical strength) in particular when hot and easy implementation. More specifically, both improved processability because of the low initial viscosity of the composition, with which for example to use lower injection pressures or to mold parts with a higher level of finesse and improved mechanical properties because of the high molecular weight achievable are possible with the solution from the invention, in the case of reactive compositions, by using compositions based on semi-crystalline reactive polyamide prepolymers. More specifically, while having a high Tg and Tm as defined, with an easy implementation of said thermoplastic material, the polyamide polymer matrix must also have a high rate of crystallization, characterized first by a gap between the melting and crystallization temperatures Tm−Tc not exceeding 40° C., preferably not exceeding 30° C. Therefore, the subject matter of the invention is to develop a polyamide composition meeting the needs already defined above:

High Tg over a wide service temperature range;

A Tm included from 290° C. to 340° C. for being easily processable, in particular by injection;

A very good suitability for crystallization in order to be able to be unmolded quickly and thus be compatible with intensive production cycles, such as those used for example in the automobile industry:

A high stiffness including when hot, in order to produce the highest possible moduli from the final material.

The present invention relates to a composition for a thermoplastic material comprising:
0 to 70% by weight, preferably 20 to 60% by weight, of short reinforcing fibers,
30 to 100% by weight, preferably 40 to 80% by weight, of a thermoplastic matrix based on at least one semi-crystalline polyamide polymer,
0 to 50% of additives and/or other polymers,
   where said semi-crystalline polyamide polymer is:
a) a reactive composition comprising or consisting of at least one reactive polyamide prepolymer precursor of said semi-crystalline polyamide polymer,
or in alternative to a)
b) a non-reactive composition of at least one polyamide polymer where said composition is that of said thermoplastic matrix defined above,
   and said reactive polyamide prepolymer for the composition a) and said polyamide polymer for the composition b) comprising or consisting of at least one BACT/XT copolyamide in which:
BACT is a unit with an amide motif present at a molar content ranging included from over 70% to 99.1%, preferably from 80 to 99%, more preferably from 90 to 99%, where BAC is chosen from among 1,3-bis(aminomethyl)cyclohexyl (1,3-BAC), 1,4-bis(aminomethyl)cyclohexyl (1,4-BAC) and a mixture thereof, and T is terephthalic acid,
XT is an amide motif unit present at a molar content ranging from 0.9 to under 30%, preferably from 1 to 20%, more preferably from 1 to 10%, where X is a C4 to C18 linear aliphatic diamine, in particular C9 to C18, preferably C9, C10, C11 or C12, and where T is terephthalic acid, preferably C10, C11 or C12.
in the BACT and/or XT units, independently of each other, up to 30 mol %, preferably 20 mol %, particularly up to 10 mol % of terephthalic acid, relative to the total quantity of dicarboxylic acids, can be replaced by other aromatic, aliphatic or cycloaliphatic dicarboxylic acids comprising 6 to 36 carbon atoms, particularly 6 to 14 carbon atoms, and
in the BACT and/or XT units, independently of each other, up to 30 mol %, preferably 20 mol %, particularly up to 10 mol %, of BAC and/or if applicable X, relative to the total quantity of the diamines, can be replaced by other diamines comprising from 4 to 36 carbon atoms, particularly 6 to 12 carbon atoms, and
in the copolyamide, not more than 30 mol %, preferably not more than 20 mol %, preferably not more than 10 mol %, relative to the total quantity of monomers, can be formed by lactams or aminocarboxylic acids, and
provided that the sum of the monomers that replace terephthalic acid, BAC and X does not exceed a concentration of 30 mol %, preferably 20 mol %, preferably 10 mol %, relative to the total quantity of the monomers used in the copolyamide, and
provided that BACT and XT units are still present in said polyamide polymer.

It is obvious that the partial replacement of monomers defined above is understood as meaning that the ranges of BACT and XT defined above, meaning that when BACT is present for example in proportion of over 70 to 99.1%, the possible partial replacement of BAC and/or T will in all cases lead to a final proportion of over 70% BACT and similarly for XT.

Said semi-crystalline polyamide polymer is therefore the semi-crystalline polyamide polymer which is the base of the thermoplastic matrix and which can be obtained from the reactive composition a) which corresponds to:
either a di-NH₂ or di-CO₂H terminated polyamide prepolymer which can react respectively with another di-CO₂H or di-NH₂ terminated polyamide prepolymer for leading to said semi-crystalline polyamide polymer,
or a NH₂ or CO₂H terminated prepolymer which can react with itself, for leading to said semi-crystalline polyamide polymer,
or a prepolymer which can react with a chain extender to lead to said semi-crystalline polyamide polymer,
or the semi-crystalline polyamide polymer is already present in the non-reactive composition b).

In other words, the present invention relates to a composition for a thermoplastic material comprising:
0 to 70% by weight, preferably 20 to 60% by weight, of short reinforcing fibers,
30 to 100% by weight, preferably 40 to 80% by weight, of a thermoplastic matrix based on at least one semi-crystalline polyamide polymer,
0 to 50% of additives and/or other polymers,
   where said composition is:
a) a reactive composition comprising or consisting of at least one reactive polyamide prepolymer precursor of said semi-crystalline polyamide polymer,
   or in alternative to a),
b) a non-reactive composition of at least one polyamide polymer where said composition is that of said thermoplastic matrix defined above,
   and said reactive polyamide prepolymer for the composition a) and said polyamide polymer for the composition b) comprising or consisting of at least one BACT/XT copolyamide in which:
BACT is a unit with an amide motif present at a molar content ranging from 70 to 99.1%, preferably from 80 to 99%, more preferably from 90 to 99%, where BAC is chosen from among 1,3-bis(aminomethyl)cyclohexyl (1,3-BAC), 1,4-bis(aminomethyl)cyclohexyl (1,4-BAC) or a mixture thereof, and T is terephthalic acid,
XT is a unit with an amide motif present at a molar content ranging from 0.9 to under 30%, preferably from 1 to 20%, more preferably from 1 to 10%, where X is a C9 to C18 linear aliphatic diamine, preferably C9, C10, C11 or C12, and where T is terephthalic acid, preferably C10, C11 or C12,
in the BACT and/or XT units, independently of each other, up to 30 mol %, preferably 20 mol %, particularly up to 10 mol % of terephthalic acid, relative to the total quantity of dicarboxylic acids, can be replaced by other aromatic, aliphatic or cycloaliphatic dicarboxylic acids comprising 6 to 36 carbon atoms, particularly 6 to 14 carbon atoms, and
in the BACT and/or XT units, independently of each other, up to 30 mol %, preferably 20 mol %, particularly up to 10 mol %, of BAC and/or if applicable X, relative to the total quantity of the diamines, can be replaced by other diamines comprising from 4 to 36 carbon atoms, particularly 6 to 12 carbon atoms, and
in the copolyamide, not more than 30 mol %, preferably not more than 20%, preferably not more than 10 mol %, relative to the total quantity of the monomers, can be formed by lactams or aminocarboxylic acids, and
provided that the sum of the monomers that replace terephthalic acid, BAC and X does not exceed a concentration of 30 mol %, preferably 20 mol %, preferably 10 mol %, relative to the total quantity of the monomers used in the copolyamide, and
provided that BACT and XT units are still present in said polyamide polymer.

The expression “said reactive polyamide prepolymer for the composition a) and said polyamide polymer for the composition b) comprising or consisting of at least one BACT/XT copolyamide means that the reactive polyamide prepolymer for the composition a) or said polyamide polymer for the composition b) consist exclusively of units with BACT and XT amide motifs in the respective proportions defined above, or the reactive polyamide prepolymer of the composition a) or said polyamide polymer from the composition b) comprise BACT and XT amide motifs in the respective proportions defined above but also other units with amide motifs.

Advantageously, the proportion of units with BACT and XT amide motifs in the reactive polyamide prepolymer from composition a) or said polyamide polymer from composition b) is over 50%, notably over 60%, in particular over 70%, preferably over 80%, notably over 90%.

The present invention therefore relates to a composition for a thermoplastic material comprising:
0 to 70% by weight, preferably 20 to 60% by weight, of short reinforcing fibers,
30 to 100% by weight, preferably 40 to 80% by weight, of a thermoplastic matrix based on at least one semi-crystalline polyamide polymer,
0 to 50% of additives and/or other polymers,
   said semi-crystalline polyamide polymer comprising or consisting of the at least one BACT/XT copolyamide wherein:
BACT is a unit with an amide motif present at a molar content ranging from 70 to 99.1%, preferably from 80 to 99%, more preferably from 90 to 99%, where BAC is chosen from among 1,3-bis(aminomethyl)cyclohexyl (1,3-BAC), 1,4-bis(aminomethyl)cyclohexyl (1,4-BAC) or a mixture thereof, and T is terephthalic acid,
XT is a unit with an amide motif present at a molar content ranging from 0.9 to under 30%, preferably from 1 to 20%, more preferably from 1 to 10%, where X is a C9 to C18 linear aliphatic diamine, preferably C9, C10, C11 or C12, and where T is terephthalic acid, preferably C10, C11 or C12,
in the BACT and/or XT units, independently of each other, up to 30 mol %, preferably 20 mol %, particularly up to 10 mol % of terephthalic acid, relative to the total quantity of dicarboxylic acids, can be replaced by other aromatic, aliphatic or cycloaliphatic dicarboxylic acids comprising 6 to 36 carbon atoms, particularly 6 to 14 carbon atoms, and
in the BACT and/or XT units, independently of each other, up to 30 mol %, preferably 20 mol %, particularly up to 10 mol %, of BAC and/or if applicable X, relative to the total quantity of the diamines, can be replaced by other diamines comprising from 4 to 36 carbon atoms, particularly 6 to 12 carbon atoms, and
in the copolyamide, not more than 30 mol %, preferably not more than 20 mol %, preferably not more than 10 mol %, relative to the total quantity of the monomers, can be formed by lactams or aminocarboxylic acids, and
provided that the sum of the monomers that replace terephthalic acid, BAC and X does not exceed a concentration of 30 mol %, preferably 20 mol %, preferably 10 mol %, relative to the total quantity of the monomers used in the copolyamide, and
provided that BACT and XT units are still present in said polyamide polymer.

The composition according to the invention may comprise short reinforcing fibers or short fibrous reinforcements.

Preferably the fibers described as short have a length included between 200 and 400 μm.

These short reinforcing fibers can be chosen among:
natural fibers
mineral fibers, those having melting temperatures Tm′ that are high and over the melting temperature Tm of said semi-crystalline polyamide from the invention and higher than the polymerization and/or implementation temperature,
the polymeric or polymer fibers having a melting temperature Tm′ or if there is not a melting temperature Tm′, a glass transition temperature Tg′, greater than the polymerization temperature or greater than the melting temperature Tm of said semi-crystalline polyamide constituting said matrix of said thermoplastic material and greater than the implementation temperature.
or mixtures of the fibers cited above.

The following can be listed as mineral fibers suitable for the invention: inorganic fibers, in particular carbon fibers, which includes fibers of nanotubes or carbon nanotubes (CNT), carbon nanofibers or graphenes; silica fibers such as glass fibers, in particular type E, R or S2; boron fibers; ceramic fibers, in particular silicon carbide fibers, boron carbide fibers, boron carbonitride fibers, silicon nitride fibers, boron nitride fibers, basalt fibers; fibers or filaments containing metals and/or their alloys; metal oxide fibers, in particular of alumina (Al₂O₃); metalized fibers such as metalized glass fibers and metalized carbon fibers or mixtures of previously cited fibers.

More specifically, these fibers can be chosen as follows:
the mineral fibers can be chosen among; carbon fibers, carbon nanotube fibers, glass fibers, in particular type E, R or S2; boron fibers; ceramic fibers, in particular silicon carbide fibers, boron carbide fibers, boron carbonitride fibers, silicon nitride fibers, boron nitride fibers, basalt fibers; fibers or filaments containing metals and/or their alloys; metal oxide fibers, like Al₂O₃; metalized fibers such as metalized glass fibers and metalized carbon fibers or mixtures of previously cited fibers, and
the polymer or polymeric fibers, subject to the conditions indicated above, are chosen among:
thermohardening polymer fibers and more particularly chosen from; unsaturated polyesters, epoxy resins, vinyl esters, phenol resins, polyurethanes, cyanoacrylates and polyimides, such as bis-maleimide resins, aminoplasts resulting from the reaction of an amine such as melamine with an aldehyde such as glyoxal or formaldehyde,
thermoplastic polymer fibers and more specifically chosen among:
polyamide fibers, in particular polyphthalamide fibers,
aramid fibers (such as Kevlar®) and aromatic polyamides such as those having one of the formulas: PPD.T, MPD.I, PAA and PPA, with PPD and MPD being respectively p- and m-phenylene diamine, PAA being polyarylamides and PPA being polyphthalamides,
fibers of polyamide block copolymers such as polyamide/polyether, fibers of polyarylether ketones (PAEK) such as polyetherether ketone (PEEK), polyetherketone ketone (PEKK), polyetherketoneetherketone ketone (PEKEKK).

The preferred short reinforcing fibers are short fibers chosen among: carbon fibers, including metalized, glass fibers, including metalized type E, R, S2, aramid fibers (like Kevlar®) or aromatic polyamide fibers, polyarylether ketone (PAEK) fibers such as polyetherether ketone (PEEK), polyetherketone ketone (PEKK) fibers, polyetherketoneetherketone ketone (PEKEKK) fibers, or mixtures thereof.

Natural fibers can be chosen among flax, ricin, wood, sisal, kenaf, coconut, hemp and jute fibers.

Preferably, reinforcing fibers present in the composition according to the invention are chosen among glass fibers, carbon fibers, flax fibers and mixtures thereof, and more preferably glass fibers and carbon fibers, and still more preferably glass fibers.

As it relates to the additives, without being limited to them, the composition according to a preferred variant of the invention more specifically comprises specific additives such as thermal stabilizers; in particular these stabilizers are antioxidants against thermal-oxidation and/or photo-oxidation of the polymer of the thermoplastic matrix and are organic or inorganic stabilizers.

The expression “organic stabilizer” or more generally a “combination of organic stabilizers,” denotes a primary antioxidant of the phenol type, a secondary antioxidant of the phosphite type and optionally other stabilizers such as a HALS, which means hindered amine light stabilizer (for example Ciba's Tinuvin 770), an anti-UV (for example Gibe's Tinuvin 312), a phenol stabilizer or a stabilizer containing phosphorus. Amine antioxidants such as Crompton's Naugard 445 or polyfunctional stabilizers such as Clariant's Nylostab S-EED can also be used.

The organic stabilizer present can be chosen, without this list being restrictive, from among:

phenol antioxidants, for example Ciba's Irganox 245, Irganox 1010, Irganox 1098, Ciba's Irganox MD1024, Great Lakes' Lowinox 44B25, Adeka Palmerole's ADK Stab AO-80.

stabilizers containing phosphorus, such as phosphites, for example Ciba's Irgafos 168,

a UV absorber, such as Ciba's Tinuvin 312,

a HALS, as previously stated,

an amine type stabilizer, such as Crompton's Naugard 445, or even a hindered amine type such as Ciba's Tinuvin 770,

a polyfunctional stabilizer such as Clariant's Nylostab S-EED.

A mixture of two or more of these organic stabilizers can obviously be envisaged.

The expression “mineral stabilizer” denotes a copper-based or metal oxide-based stabilizer such as described in US 2008/0146717. The following can be listed as examples of mineral stabilizers: halides or acetates of copper or iron oxides such as FeO, Fe₂O₃, Fe₃O₄ or a mixture thereof. Optionally, other metals such as silver could be considered but these are known to be less effective. These copper-based compounds are typically associated with alkali metal halides, particularly potassium halides.

These mineral stabilizers are more particularly employed when the structures must have improved long-term heat resistance in hot air, in particular for temperatures greater than or equal to 100-120° C., because they tend to prevent breaks in polymer chains.

More particularly, a copper-based stabilizer is understood to mean a compound comprising at least one copper atom, in particular in ionizable, ionic form, for example in the form of a complex.

The copper-based stabilizer can be chosen from copper (I) chloride, copper (II) chloride, copper (I) bromide, copper (II) bromide, copper (I) iodide, copper (II) iodide, copper (I) acetate and copper (II) acetate. Mention may be made of halides and acetates of other metals such as silver in combination with the copper-based stabilizer. These copper-based compounds are typically associated with alkali metal halides. A well known example is the mixture of CuI and KI, where the ratio CuI:KI is typically inclusively between 1:5 to 1:15. An example of such a stabilizer is Ciba's Polyadd P201.

More details on copper-based stabilizers are found in U.S. Pat. No. 2,705,227. More recently, copper-based stabilizers such as copper complexes such as Bruggemann's Bruggolen H3336, H3337, H3373 have appeared.

Advantageously, the copper-based stabilizer is chosen from copper halides, copper acetate, copper halides or copper acetate in mixture with at least one alkali metal halide, and mixtures thereof, preferably mixtures of copper iodide and potassium iodide (CuI/KI).

The additive can also be an impact modifier, advantageously consisting of a polymer having a flexural modulus less than 100 MPa measured according to the ISO 178 standard and Tg below 0° C. (measured according to the 11357-2:2013 standard near the inflection point of the DSC thermogram), in particular a polyolefin coupled or not with a PEBA (polyether block amide) having a flexural modulus <200 MPa.

The polyolefin of the impact modifier can be functionalized or non-functionalized or be a mixture of at least one functionalized polyolefin and/or least one non-functionalized polyolefin.

Additives could also be fillers which can in particular be any filler known to the person skilled in the art in the domain of thermoplastic materials. It can even involve fillers that are heat conducting and/or electricity conducting, such as metal powder, powdered carbon black, carbon fibrils, carbon nanotubes (CTN), silicon carbide, boron carbonitride, boron nitride or silicon. Application WO 2010/130930 from the Applicant can be referred to on this subject.

Reinforcing fibers, whether they are long, short or continuous, are excluded from the additives and particularly the term “inorganic filler” excludes long, short or continuous reinforcing fibers.

The additives can also be halogen-free flame retardant agents, such as described in US 2008/0274355 and in particular a metal salt chosen among a phosphinic acid metal salt, a diphosphinic acid metal salt, a polymer containing at least one phosphinic acid metal salt, a polymer containing at least one diphosphinic acid or red phosphorus metal salt, antimony oxide, zinc oxide, iron oxide, magnesium oxide or metal borates such as zinc borate or even melamine pyrophosphates and melamine cyanurate. They can also be halogenated flame retardant agents such as brominated or polybrominated polystyrene, brominated polycarbonate or brominated phenol.

Advantageously, the additive is chosen among an antioxidant, a thermal stabilizer, a UV absorber, a light stabilizer, an impact modifier, a lubricant, an inorganic filler, a flame retardant agent, a nucleating agent, in particular a mineral filler such as talc, and a colorant.

The expression “other polymers” designates any thermoplastic polymer and in particular a polyamide polymer, in particular an aliphatic, cycloaliphatic or aromatic polyamide, and which can be microcrystalline or amorphous.

The expression “non-reactive composition” means that the composition is polyamide polymer-based whose molecular weight is no longer likely to change significantly, meaning that the number-average molecular weight (Mn) thereof changes less than 50% during implementation thereof and therefore corresponds to the final polyamide polymer of the thermoplastic matrix.

These polyamides according to compositional b) are non-reactive, either by the low level of (residual) reactive functions present, in particular with a level of said functions <120 meq/kg, or by the presence of the same type of end of chain terminal functions and therefore non-reactive with each other, or by modification and blocking of said reactive functions by a monofunctional reactive composition, for example the amine functions by modification reaction with a monoacid or a monoisocyanate and for carboxylic functions by reaction with a monoamine.

Advantageously, the number-average molecular weight (Mn) of said final polyamide polymer of the thermoplastic matrix of said material is preferably in a range extending from 6000 to 40,000 g/mole, preferably 10,000 to 30,000 g/mole such as determined by the calculation done from the level of terminal functions determined by potentiometric titration in solution and the functionality of said prepolymers or by NMR. These Mn values can correspond to inherent viscosities greater than or equal to 0.7 such as determined according to the ISO 307:2007 standard by changing the solution (using m-cresol in place of sulfuric acid and the temperature at 20° C.).

In contrast, the expression “reactive composition” means that the molecular weight of said reactive composition changes during implementation by reaction of reactive prepolymers with each other by condensation or with a chain extender by polyaddition and without elimination of volatile byproducts for leading to the final polyamide polymer of the thermoplastic matrix. 1,3-BAC (or 1,3-bis(aminomethyl)cyclohexyl, CAS number 2579-20-6) is a cycloaliphatic diamine monomer obtained in particular by hydrogenating meta-xylene diamine (MXDA). 1,3-BAC exists in the form of two isomers, cis and trans, where CAS number 2579-20-6 corresponds to a mixture of isomers.

1,4-BAC (or 1,4-bis(aminomethyl)cyclohexyl, CAS number 2549-07-9) is a cycloaliphatic diamine monomer obtained in particular by hydrogenating para-xylene diamine (PXDA). 1,4-BAC exists in the form of two isomers, cis and trans, where CAS number 2549-07-9 corresponds to a mixture of isomers.

Advantageously, the 1,3-BAC or 1,4-BAC used in the BACT unit is a mixture of cis and trans isomers in respective proportions of 0/100 to 100/0, in particular from 75/25 to 25/75.

Advantageously, the proportion of cis isomer in the 1,3-BAC is greater than 60%, preferably greater than 70%, particularly greater than 80%, in particular greater than 90%.

Advantageously, the proportion of trans isomer in the 1,4-BAC is greater than 60%, preferably greater than 70%, particularly greater than 80%, in particular greater than 90%.

BAC and/or X can be replaced, independently of each other, up to 30 mol % by other diamines defined above, in particular by a linear or branched aliphatic diamine, a cycloaliphatic diamine or a arylaromatic diamine such as meta-xylene diamine (MXDA).

As an example, the linear or branched aliphatic diamine is chosen from 1,4-butanediamine, 1,5-pentanediamine, 2-methyl-1,5-pentanediamine (MPMD), 1,6-hexanediamine, 1,8-octanediamine (OMDA), 1,9-nonanediamine (NMDA), 2-methyl-1,8-octane-diamine (MODA), 2,2,4-trimethylhexamethylenediamine (TMHMD), 2,4,4-trimethylhexamethylenediamine (TMHMD), 5-methyl-1,9-nonanediamine, 1,11-undecanediamine, 2-butyl-2-ethyl-1,5-pentanediamine, 1,12-dodecanediamine, 1,13-tridecanediamine, 1,14-tetradecanediamine, 1,16-hexadecanediamine and 1,18-octadecanediamine.

The cycloaliphatic diamine can be chosen from isophoronediamine, norbornanedimethylamine, 4,4′-diaminodicyclohexylmethane (PACM), 2,2-(4,4′-diamino-dicyclohexyl)propane (PACP), and 3,3′-dimethyl-4,4′-diaminodicyclohexylethane (MACM).

T can be replaced up to 30 mol % by other carboxylic diacids defined above, in particular by other aromatic, aliphatic or cycloaliphatic carboxylic diacids.

The aromatic dicarboxylic acids can be chosen from naphthalenedicarboxylic acid (NDA) and isophthalic acid (IPA).

The aliphatic carboxylic diacids can be chosen from adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid and dimerized fatty acids.

The cycloaliphatic dicarboxylic acids can be chosen from cis- and/or trans-cyclohexane-1,4-dicarboxylic acid and/or cis- and/or trans-cyclohexane-1,3-dicarboxylic acid (CHDA).

BAC and/or X and/or T can be replaced, independently of each other, up to 30 mol % by lactams or aminocarboxylic acids.

The lactams and aminocarboxylic acids can be chosen from caprolactam (CL), α,ω-aminocaproic acid, α,ω-aminononanoic acid, α,ω-aminoundecanoic acid (AUA), lauryllactam (LL) and α,ω-aminododecanoic acid (ADA).

30 mol % maximum, relative to the total sum of the BAC, X and T monomers, of replacement, whether by another diamine, another diacid, a lactam or an aminocarboxylic acid or any mixture of these is possible.

Advantageously, 20 mol % maximum, relative to the total sum of the BAC, X and T monomers, of replacement, whether by another diamine, another diacid, a lactam or an aminocarboxylic acid or any mixture of these is possible.

Advantageously, 10 mol % maximum, relative to the total sum of the BAC, X and T monomers, of replacement, whether by another diamine, another diacid, a lactam or an aminocarboxylic acid or any mixture of these is possible.

In an advantageous embodiment, the present invention relates to one of the compositions for a thermoplastic material number 1 to 12 defined below, said composition comprising a semi-crystalline polyamide polymer, optionally short reinforcing fibers, where said semi-crystalline polyamide polymer comprises a BACT/XT copolyamide in proportions defined in Table 1 below:

TABLE I

| | | Short | | |
|---|---|---|---|---|
| | Semi-crystalline | reinforcing | | |
| | polyamide polymer | fibers | BACT | XT |
| Composition | % by weight | % by weight | molar % | molar % |
| 1 | 30-100 | 0-70 | >70-99.1 | 0.9-<30 |
| 2 | 30-100 | 0-70 | 80-99 | 1-20 |
| 3 | 30-100 | 0-70 | 90-99 | 1-20 |
| 4 | 40-80 | 0-70 | >70-99.1 | 0.9-<30 |
| 5 | 40-80 | 0-70 | 80-99 | 1-20 |
| 6 | 40-80 | 0-70 | 90-99 | 1-10 |
| 7 | 30-100 | 20-60 | >70-99.1 | 0.9-<30 |
| 8 | 30-100 | 20-60 | 80-99 | 1-20 |
| 9 | 30-100 | 20-60 | 90-99 | 1-10 |
| 10 | 40-80 | 20-60 | >70-99.1 | 0.9-<30 |
| 11 | 40-80 | 20-60 | 80-99 | 1-20 |
| 12 | 40-80 | 20-60 | 90-99 | 1-10 |

Advantageously, the compositions 1 to 12 comprise from 0 to 50% by weight additives and/or other polymers.

Advantageously, said compositions consist of a semi-crystalline polyamide polymer, optionally short reinforcing fibers, and from 0 to 50% by weight of additives and/or other polymers, where said semi-crystalline polyamide polymer comprises a BACT/XT copolyamide in the proportions defined in Table I.

Advantageously, said compositions consist of a semi-crystalline polyamide polymer, optionally short reinforcing fibers, and from 0 to 50% by weight of additives and/or other polymers, where said semi-crystalline polyamide polymer consists of a BACT/XT copolyamide in the proportions defined in Table I.

Advantageously, the proportion of additives and/or other polymers in the compositions defined above is more than 0 to 50% by weight.

Advantageously, in the compositions defined above, X is a C9, C10, C11 or C12 diamine, particularly C10, C11 or C12.

The inventors have therefore unexpectedly found that the compositions from the invention had an excellent fitness for crystallization, a high Tg and Tm, and especially a higher enthalpy (and therefore higher modulus when hot) than compositions from the prior art.

In an advantageous embodiment, the present invention relates to a composition as defined above, wherein said semi-crystalline polyamide polymer has a melting temperature Tm included from 290° C. to 340° C., preferably included from 300° C. to 330° C., more preferably included from 310° C. to 330° C., as determined according to the ISO 11357-3 (2013) standard.

In an advantageous embodiment, the present invention relates to a composition as defined above, wherein said semi-crystalline polyamide polymer has a glass transition temperature Tg >150° C., preferably >160° C., more preferably >170° C., determined according to the ISO 11357-2:2013 standard.

Advantageously, the Tg is included from 155 to 190° C.

In an advantageous embodiment, the present invention relates to a composition as defined above, wherein said semi-crystalline polyamide polymer has a difference between the melting temperature and the crystallization temperature Tm−Tc<40° C., preferably <30° C., determined according to the ISO 11357-3:2013 standard.

In an advantageous embodiment, the present invention relates to a composition as defined above, characterized in that the enthalpy of crystallization of the semi-crystalline polyamide polymer, measured by differential scanning calorimetry (DSC) according to the ISO 11357-3:2013 standard, is greater than 40 J/g, preferably greater than 45 J/g, and even more preferably greater than 50 J/g.

In an advantageous embodiment, the present invention relates to a composition as defined above, characterized in that said semi-crystalline polyamide polymer has a melting temperature: Tm included from 290° C. to 340° C. and Tg>150° C.

In an advantageous embodiment, the present invention relates to a composition as defined above, characterized in that said semi-crystalline polyamide polymer has a melting temperature: Tm included from 290° C. to 340° C. and Tg>160° C.

In an advantageous embodiment, the present invention relates to a composition as defined above, characterized in that said semi-crystalline polyamide polymer has a melting temperature: Tm included from 290° C. to 340° C. and Tg>170° C.

In an advantageous embodiment, the present invention relates to a composition as defined above, characterized in that said semi-crystalline polyamide polymer has a melting temperature: Tm included from 300° C. to 330° C. and Tg>150° C.

In an advantageous embodiment, the present invention relates to a composition as defined above, characterized in that said semi-crystalline polyamide polymer has a melting temperature: Tm included from 300° C. to 330° C. and Tg>160° C.

In an advantageous embodiment, the present invention relates to a composition as defined above, characterized in that said semi-crystalline polyamide polymer has a melting temperature: Tm included from 300° C. to 330° C. and Tg>170° C.

In an advantageous embodiment, the present invention relates to a composition as defined above, characterized in that said semi-crystalline polyamide polymer has a melting temperature: Tm included from 310° C. to 330° C. and Tg>150° C.

In an advantageous embodiment, the present invention relates to a composition as defined above, characterized in that said semi-crystalline polyamide polymer has a melting temperature: Tm included from 310° C. to 330° C. and Tg>160° C.

In an advantageous embodiment, the present invention relates to a composition as defined above, characterized in that said semi-crystalline polyamide polymer has a melting temperature: Tm included from 310° C. to 330° C. and Tg>170° C.

In an advantageous embodiment, the present invention relates to a composition as defined above, characterized in that said semi-crystalline polyamide polymer has the following characteristics (Table II):

TABLE II

| | | | | Tm-Tc | Delta Hc |
|---|---|---|---|---|---|
| Composition No. | Initial compositions | Tm (° C.) | Tg (° C.) | (° C.) | (J/g) |
| 13 | Compositions 1 to 12 | 290-340 | >150° C. | | |
| 14 | Compositions 1 to 12 | 290-340 | >160° C. | | |
| 15 | Compositions 1 to 12 | 290-340 | >170° C. | | |
| 16 | Compositions 1 to 12 | 300-330 | >150° C. | | |
| 17 | Compositions 1 to 12 | 300-330 | >160° C. | | |
| 18 | Compositions 1 to 12 | 300-330 | >170° C. | | |
| 19 | Compositions 1 to 12 | 310-330 | >150° C. | | |
| 20 | Compositions 1 to 12 | 310-330 | >160° C. | | |
| 21 | Compositions 1 to 12 | 310-330 | >170° C. | | |
| 22 | Compositions 1 to 12 | 290-340 | >150° C. | <40 | |
| 23 | Compositions 1 to 12 | 290-340 | >160° C. | <40 | |
| 24 | Compositions 1 to 12 | 290-340 | >170° C. | <40 | |
| 25 | Compositions 1 to 12 | 300-330 | >150° C. | <40 | |
| 26 | Compositions 1 to 12 | 300-330 | >160° C. | <40 | |
| 27 | Compositions 1 to 12 | 300-330 | >170° C. | <40 | |
| 28 | Compositions 1 to 12 | 310-330 | >150° C. | <40 | |
| 29 | Compositions 1 to 12 | 310-330 | >160° C. | <40 | |
| 30 | Compositions 1 to 12 | 310-330 | >170° C. | <40 | |
| 31 | Compositions 1 to 12 | 290-340 | >150° C. | <30 | |
| 32 | Compositions 1 to 12 | 290-340 | >160° C. | <30 | |
| 33 | Compositions 1 to 12 | 290-340 | >170° C. | <30 | |
| 34 | Compositions 1 to 12 | 300-330 | >150° C. | <30 | |
| 35 | Compositions 1 to 12 | 300-330 | >160° C. | <30 | |
| 36 | Compositions 1 to 12 | 300-330 | >170° C. | <30 | |
| 37 | Compositions 1 to 12 | 310-330 | >150° C. | <30 | |
| 38 | Compositions 1 to 12 | 310-330 | >160° C. | <30 | |
| 39 | Compositions 1 to 12 | 310-330 | >170° C. | <30 | |
| 40 | Compositions 1 to 12 | 290-340 | >150° C. | <40 | >40 |
| 41 | Compositions 1 to 12 | 290-340 | >160° C. | <40 | >40 |
| 42 | Compositions 1 to 12 | 290-340 | >170° C. | <40 | >40 |
| 43 | Compositions 1 to 12 | 300-330 | >150° C. | <40 | >40 |
| 44 | Compositions 1 to 12 | 300-330 | >160° C. | <40 | >40 |
| 45 | Compositions 1 to 12 | 300-330 | >170° C. | <40 | >40 |
| 46 | Compositions 1 to 12 | 310-330 | >150° C. | <40 | >40 |
| 47 | Compositions 1 to 12 | 310-330 | >160° C. | <40 | >40 |
| 48 | Compositions 1 to 12 | 310-330 | >170° C. | <40 | >40 |
| 49 | Compositions 1 to 12 | 290-340 | >150° C. | <30 | >40 |
| 50 | Compositions 1 to 12 | 290-340 | >160° C. | <30 | >40 |
| 51 | Compositions 1 to 12 | 290-340 | >170° C. | <30 | >40 |
| 52 | Compositions 1 to 12 | 300-330 | >150° C. | <30 | >40 |
| 53 | Compositions 1 to 12 | 300-330 | >160° C. | <30 | >40 |
| 54 | Compositions 1 to 12 | 300-330 | >170° C. | <30 | >40 |
| 55 | Compositions 1 to 12 | 310-330 | >150° C. | <30 | >40 |
| 56 | Compositions 1 to 12 | 310-330 | >160° C. | <30 | >40 |
| 57 | Compositions 1 to 12 | 310-330 | >170° C. | <30 | >40 |
| 58 | Compositions 1 to 12 | 290-340 | >150° C. | <40 | >45 |
| 59 | Compositions 1 to 12 | 290-340 | >160° C. | <40 | >45 |
| 60 | Compositions 1 to 12 | 290-340 | >170° C. | <40 | >45 |
| 61 | Compositions 1 to 12 | 300-330 | >150° C. | <40 | >45 |
| 62 | Compositions 1 to 12 | 300-330 | >160° C. | <40 | >45 |
| 63 | Compositions 1 to 12 | 300-330 | >170° C. | <40 | >45 |
| 64 | Compositions 1 to 12 | 310-330 | >150° C. | <40 | >45 |
| 65 | Compositions 1 to 12 | 310-330 | >160° C. | <40 | >45 |
| 66 | Compositions 1 to 12 | 310-330 | >170° C. | <40 | >45 |
| 67 | Compositions 1 to 12 | 290-340 | >150° C. | <30 | >45 |
| 68 | Compositions 1 to 12 | 290-340 | >160° C. | <30 | >45 |
| 69 | Compositions 1 to 12 | 290-340 | >170° C. | <30 | >45 |
| 70 | Compositions 1 to 12 | 300-330 | >150° C. | <30 | >45 |
| 71 | Compositions 1 to 12 | 300-330 | >160° C. | <30 | >45 |
| 72 | Compositions 1 to 12 | 300-330 | >170° C. | <30 | >45 |
| 73 | Compositions 1 to 12 | 310-330 | >150° C. | <30 | >45 |
| 74 | Compositions 1 to 12 | 310-330 | >160° C. | <30 | >45 |
| 75 | Compositions 1 to 12 | 310-330 | >170° C. | <30 | >45 |
| 76 | Compositions 1 to 12 | 290-340 | >150° C. | <40 | >50 |
| 77 | Compositions 1 to 12 | 290-340 | >160° C. | <40 | >50 |
| 78 | Compositions 1 to 12 | 290-340 | >170° C. | <40 | >50 |
| 79 | Compositions 1 to 12 | 300-330 | >150° C. | <40 | >50 |
| 80 | Compositions 1 to 12 | 300-330 | >160° C. | <40 | >50 |
| 81 | Compositions 1 to 12 | 300-330 | >170° C. | <40 | >50 |
| 82 | Compositions 1 to 12 | 310-330 | >150° C. | <40 | >50 |
| 83 | Compositions 1 to 12 | 310-330 | >160° C. | <40 | >50 |
| 84 | Compositions 1 to 12 | 310-330 | >170° C. | <40 | >50 |
| 85 | Compositions 1 to 12 | 290-340 | >150° C. | <30 | >50 |
| 86 | Compositions 1 to 12 | 290-340 | >160° C. | <30 | >50 |
| 87 | Compositions 1 to 12 | 290-340 | >170° C. | <30 | >50 |
| 88 | Compositions 1 to 12 | 300-330 | >150° C. | <30 | >50 |
| 89 | Compositions 1 to 12 | 300-330 | >160° C. | <30 | >50 |
| 90 | Compositions 1 to 12 | 300-330 | >170° C. | <30 | >50 |
| 91 | Compositions 1 to 12 | 310-330 | >150° C. | <30 | >50 |
| 92 | Compositions 1 to 12 | 310-330 | >160° C. | <30 | >50 |
| 93 | Compositions 1 to 12 | 310-330 | >170° C. | <30 | >50 |

In an advantageous embodiment, the present invention relates to a composition as defined above, characterized in that the BAC is 1,3-BAC.

Advantageously, 1,3-BAC is a mixture of cis and trans isomers in a respective proportion of 0/100 to 100/0, in particular from 75/25 to 25/75.

Advantageously, the proportion of cis isomer in the 1,3-BAC is greater than 60%, preferably greater than 70%, particularly greater than 80%, in particular greater than 90%.

In an advantageous embodiment, the present invention relates to a composition as defined above, wherein the BAC is 1,3-BAC and XT is chosen from 9T, 10T, 11T and 12T, more preferably 10T, 11T and 12T.

Advantageously, XT is 11T or 12T.

Advantageously, XT is 10T, 10 corresponding to 1,10-decanediamine.

In an advantageous embodiment, the present invention relates to a composition as defined above, wherein the sum of the monomers that replace terephthalic acid, BAC and X is equal to 0. In this latter embodiment, there is therefore no more possible substitution of the monomers in compositions 1 to 93 as defined above.

In an advantageous embodiment, the present invention relates to a composition as defined above, characterized in that said semi-crystalline polyamide polymer is non-reactive composition according to b).

This means that said composition is the same as that of the matrix polymer (polyamide) of said thermoplastic material because there is no reaction in this composition, which remains stable and unchanging in terms of molecular weight during heating thereof for the implementation of the thermoplastic material from the invention. The characteristics of the polyamide polymer in this composition are the same as those from the final polymer, with Tm, Tg, Tm−Tc and Delta Hc as already defined above.

The polyam ides according to b) are obtained by conventional polycondensation reaction from component monomers which are diamines, diacids and possibly amino acids or lactams, in particular in the context of substitution of monomers.

In an advantageous embodiment, the present invention relates to a composition such as defined above characterized in that said polyamide composition is a reactive prepolymer composition according to a) and precursor of said polyamide polymer of said thermoplastic material matrix.

Depending on the reactive composition a), three possibilities given in detail below can be distinguished:

Advantageously, said composition a) comprises or consists of at least one reactive prepolymer carrying two terminal functions X′ and Y′ on the same chain, where these functions are respectively co-reactive with each other by condensation, where X′ and Y′ are amine and carboxyl, or carboxyl and amine respectively.

The prepolymer is a reactive polyamide carrying on the same chain (meaning on the same prepolymer) two terminal functions X′ and Y′ which are respectively co-reactive with each other by condensation.

This condensation (or polycondensation) reaction can cause the elimination of byproducts. These can be discharged by preferably working with a method using an open mold technology. In the case of a closed mold method, there is a step of degassing, preferably under vacuum, of the byproducts eliminated by the reaction; this is done in order to avoid the formation of microbubbles of byproducts in the final thermoplastic material, since microbubbles can affect the mechanical performance of said material if they are not eliminated in this way.

The term “reactive” means that the Mn of the prepolymer changes by more than 50% after reaction with itself or with another prepolymer or even by chain extending.

After condensation, the characteristics of the resulting final polyamide polymer in this composition are the same, with Tm, Tg, Tm−Tc and Delta Hc as already defined above.

Advantageously, said reactive composition a) comprises at least two polyamide prepolymers reactive with each other each respectively carrying two identical terminal functions X′ and Y′, where said function X′ of one prepolymer can react only with said function Y′ of the other prepolymer, in particular by condensation, more specifically where X′ and Y′ are respectively amine and carboxyl, or carboxyl and amine.

In this way, this condensation (or polycondensation) reaction can cause the elimination of byproducts, which can be eliminated as defined above.

After condensation, the characteristics of the resulting final polyamide polymer in this composition are the same, with Tm, Tg, Tm−Tc and Delta Hc as already defined above.

Advantageously said composition a) or precursor composition comprises or consists of:
a1) at least one thermoplastic polyamide prepolymer of said polymer, bearing n reactive terminal functions X′, chosen from: —NH₂, —CO₂H, and —OH preferably NH₂ and —CO₂H, with n being from 1 to 3, preferably from 1 to 2, more preferably 1 or 2, more particularly 2
a2) at least one chain extender Y-A′-Y, where A′is a dihydrocarbon substituent with non-polymeric structure and bearing 2 identical terminal reactive functions Y, reactive by polyaddition with at least one function X′ of said prepolymer a1), preferably a molecular weight less than 500, more preferably less than 400.

The following can be cited as suitable examples of extenders a2) depending on the functions X′ carried by said semi-crystalline polyamide prepolymer a1):

when X′ is NH₂ or OH, preferably NH₂:
Either the chain extender Y-A′-Y corresponds to
   Y chosen among the groups: maleimide, isocyanate which can be blocked, oxazinone, oxazolinone and epoxy,
   and
   A′ is a hydrocarbon spacer optionally comprising one or more heteroatoms, and connecting the Y functions with each other, in particular A′ is a hydrocarbon spacer or a carbon substituent carrying reactive functions or Y groups, chosen among:
      a covalent bond between two Y functions (groups) in the case where Y=oxazinone and oxazolinone or
      an aliphatic hydrocarbon chain, or an aromatic and/or cycloaliphatic hydrocarbon chain, where these two latter comprise at least one optionally substituted 5- or 6-membered carbon ring, optionally with said aliphatic hydrocarbon chain having a molecular weight from 14 to 400 g·mol⁻¹
   Or, the chain extender Y-A′-Y corresponds to Y being a caprolactam group and where A′ can be a carbonyl substituent such as carbonyl bis caprolactam or where A′ can be a terephthaloyl or an isophthaloyl,
   Or, the chain extender Y-A′-Y carries a cyclic anhydride group Y and preferably this extender is chosen among a cycloaliphatic and/or aromatic carboxylic dianhydride and more preferably it is chosen among: ethylenetetracarboxylicdianhydride, pyromellitic dianhydride, 3,3′,4,4′-biphenyltetracarboxylic dianhydride, 1,4,5,8-naphthalenetetracarboxylic dianhydride, perylenetetracarboxylic dianhydride, 3,3′,4,4′-benzophenone tetracarboxylic dianhydride, 1,2,3,4-cyclobutanetetracarboxylic dianhydride, hexafluoroisopropylidene bisphthalic dianhydride, 9,9-bis(trifluoromethyl)xanthenetetracarboxylic dianhydride, 3,3′,4,4′-diphenylsulfonetetracarboxylic dianhydride, bicyclo[2.2.2]oct-7-ene-2,3,5,6-tetracarboxylic dianhydride, 1,2,3,4-cyclopentanetetracarboxylic dianhydride, 3,3′,4,4′-diphenyl ether tetracarboxylic dianhydride or mixtures thereof and
when X′ is COOH:
   said chain extender Y-A′-Y corresponds to:
      Y chosen among the following groups: epoxy, oxazoline, oxazine, imidazoline or aziridine, like 1,1′-iso-or terephthaloyl-bis (2-methylaziridine)
      A′ being a carbon spacer (substituent) such as defined above.

More specifically, when in said extender Y-A′-Y, said function Y is chosen among oxazinone, oxazolinone, oxazine, oxazoline or imidazoline then in that case in the chain extender represented by Y-A′-Y, A′ can represent an alkylene such as —(CH₂)ₘ— with m ranging from 1 to 14 and preferably from 2 to 10 or A′ can represent a substituted (alkyl) or unsubstituted cycloalkylene and/or arylene, like the benzenic arylenes, such as o-, m-, p-phenylenes or naphthalenic arylenes and preferably A′ is an arylene and/or a cycloalkylene.

In the case of carbonyl- or terephthaloyl- or isophthaloyl-biscaprolactam as Y-A′-Y chain extender, the preferred conditions avoid the elimination of byproducts, like caprolactam, when said polymerization is implemented in the molten state.

In the possible case cited above where Y represents a blocked isocyanate function, this blocking can be obtained by agents blocking the isocyanate function, like epsilon-caprolactam, methyl ethyl ketoxime, dimethyl pyrazole and diethyl malonate.

Similarly, in the case with the extender is a dianhydride reacting with a P(X′)n prepolymer where X′═NH₂, the preferred conditions avoid any imide ring formation during the polymerization and during the implementation in the molten state.

The following can be given as examples of chain extenders with reactive function Y=epoxy which are suitable for the implementation of the invention: aliphatic, cycloaliphatic or aromatic diepoxides which could be substituted. The following can be given as examples of aliphatic diepoxides: diglycidyl ethers of aliphatic dials, like aromatic diepoxides of bisphenol A diglycidyl ethers such as bisphenol A diglycidyl ether (BADGE) and as examples of cycloaliphatic diepoxides: diglycidyl ethers of cycloaliphatic dials or hydrogenated bisphenol A. More generally, the following can be cited as suitable examples of diepoxides according to the invention: bisphenol A diglycidyl ether (BADGE) and the hydrogenated (cycloaliphatic) derivative thereof, bisphenol F diglycidyl ether, tetrabromo bisphenol A diglycidyl ether or hydroquinone diglycidyl ethers, ethylene glycol diglycidyl ether, propylene glycol diglycidyl ether, butylene glycol diglycidyl ether, neopentyl glycol diglycidyl ether, 1,4-butanediol diglycidyl ether, 1,6-hexanediol diglycidyl ether, cyclohexanedimethanol diglycidyl ether, polyethylene glycol diglycidyl ether with Mn<500, polypropylene glycol diglycidyl ether with Mn<500, polytetramethylene glycol diglycidyl ether with Mn<500, resorcinol diglycidyl ether, neopentylglycol diglycidyl ether. bisphenol A polyethylene glycol diglycidyl ether with Mn<500, bisphenol A polypropyleneglycol diglycidyl ether with Mn<500, carboxylic acid diglycidyl esters such as terephthalic acid glycidyl ester or epoxidized diolefins (dienes) or epoxidized fatty acids with two ethylene unsaturations, diglycidyl 1,2-cyclohexanedicarboxylate and mixtures of the diepoxides listed.

As examples of chain extenders carrying oxazoline or oxazine Y reactive functions suitable for the implementation of the invention, reference can be made to those described with references “A”, “B”, “C” and “D” on page 7 of the application EP 0,581,642, and also the preparation processes thereof and the reaction modes thereof which are disclosed therein, In this document, “A” is bisoxazoline, “B” bisoxazine, “C” 1,3-phenylenebisoxazoline and “D” 1,4-phenylenebisoxazoline.

As examples of imidazoline Y reactive function chain extenders suitable for implementation of the invention, reference can be made to those described (“A” to “F”) on pages 7 to 8 and Table 1 on page 10 of the application EP 0,739,924 and also the preparation processes thereof and the reaction modes which are described therein.

As examples of Y=oxazinone or oxazolinone reactive function chain extenders which are suitable for implementation of the invention, reference can be made to those described with references “A” to “D” on pages 7 to 8 of the application EP 0,581,641 and also the preparation processes thereof and the reaction modes thereof which are disclosed therein.

Y groups that are derived from oxazinone or oxazolinone benzoxazinone where spacer A′ can be a single covalent bond with respective corresponding extenders being bis-(benzoxazinone), bisoxazinone and bisoxazolinone can be given as examples of suitable oxazinone (6-membered ring) and oxazolinone (5-membered ring) Y groups. A′ can also be a C₁ to C₁₄ alkylene, preferably C₂ to C₁₀, but preferably A′ is an arylene and more specifically it can be a phenylene (substituted by Y in the 1,2 or 1,3 or 1,4 positions) or a naphthalene substituent (disubstituted with Y) or a phthaloyl (iso- or terephthaloyl) or A° can be a cycloalkylene.

For Y functions like oxazine (6-membered ring), oxazoline (5-membered ring) and imidazoline (5-membered ring), the substituent A′ can be as described above where A′ can be a single covalent bond and where the respective corresponding extenders are: bisoxazine, bisoxazoline and bis imidazoline. A′ can also be a C₁ to C₁₄ alkylene, preferably C₂ to C₁₀. The substituent A′ is preferably an arylene and more specifically it can be a phenylene (substituted by Y in positions 1,2 or 1,3 or 1,4) or naphthalene substituent (disubstituted with Y) or a phthaloyl (iso- or terephthaloyl) or A′ can be a cycloalkylene.

In the case where Y=aziridine (3-membered nitrogen heterocycle equivalent to ethylene oxide by replacing the ether —O— by —NH—), the substituent A′ can be phthaloyl (1,1′-iso- or terephthaloyl) with 1,1′-isophthaloyl-bis(2-methyl aziridine) as an example of chain extender of this type.

The (poly)addition reaction can be accelerated and thus the production cycle shortened with the presence of a catalyst for the reaction between said prepolymer P(X′)n and said Y-A′-Y extender at a level ranging from 0.001 to 2%, preferably from 0.01 to 0.5% relative to the total weight of both co-reactants given.

According to a specific case of the choice of said extender, A′ can represent an alkylene, such as —(CH₂)ₘ— with m ranging from 1 to 14 and preferably 2 to 10 or represent an alkyl substituted or unsubstituted arylene, like benzene arylenes (like o-, m- or p-phenylene) or naphthalene (with arylenes: naphthalenylene). Preferably, A′ represents an arylene which can be substituted or unsubstituted benzene or naphthalene.

As already indicated, said chain extender (a2) has a non-polymeric structure and preferably a molecular weight less than or equal to 500, more preferably less than or equal to 400.

Said reactive prepolymers of said reactive composition a), according to the three options given above, have a number-average molecular weight Mn ranging preferably from 500 to 20,000, in particular from 500 to 10,000, especially 1000 to 6000. All the weights Mn are determined by potentiometer or by NMR (Postma et al., (Polymer, 47, 1899-1911 (2006)).

In the case of reactive compositions from the invention according to definition a), said reactive prepolymers are prepared by conventional polycondensation reaction between the corresponding diamine and diacid components and possibly (depending on substitutions) amino acids or lactams. The prepolymers carrying X′ and Y′ amine and carboxyl functions on the same chain can be obtained for example by adding a combination of monomers (amino acid, diamine, diacid) having in total an equal quantity of amine and carboxyl motifs, but without driving the reaction to a total conversion. Another way to produce these prepolymers carrying an X′ function and a Y″ function is, for example, by combining a prepolymer carrying 2 identical X′=amine functions, with a diacid prepolymer carrying Y′: carboxyl, with an overall molar level of acid functions equal to that of the starting amine functions X′.

To produce functionalized prepolymers with identical functions (amine or carboxyl) on the same chain, it is sufficient to have an excess of diamine (or of overall amine functions) to have amine terminal functions or an excess of diacid (or of overall carboxyl functions) to have carboxyl terminal functions.

In the case of a prepolymer P(X′)n with n identical X′ functions, the functionality I can be obtained in the presence of a blocking monofunctional component (monoacid or monoamine depending on the nature of X′=amine or carboxyl).

An n=2 functionality can be obtained from difunctional components: diamines and diacids, with excess of one for binding X′ depending on this excess.

For n=3 for example, for prepolymer P(X′)n, a tri-functional component needs to be present, for example presence of a triamine (one mole per chain of prepolymer) with a diamine in the reaction with a diacid. The preferred functionality for P(X′)n is n =2.

In an advantageous embodiment, the present invention relates to a composition such as defined above, where said composition a) or precursor composition, comprises or consists of:
a1) at least one thermoplastic polyamide prepolymer of said polymer, bearing n reactive terminal functions X′, and
a2) at least one chain extender Y-A′-Y,
   wherein X′ is NH₂ or OH, in particular NH₂, and Y is chosen among an anhydride, in particular 3,3′,4,4′-benzophenone tetracarboxylic dianhydride, an oxazinone, an oxazolinone and an epoxy

In an advantageous embodiment, the present invention relates to a composition such as defined above, where said composition a) or precursor composition, comprises or consists of:
a1) at least one thermoplastic polyamide prepolymer of said polymer, bearing n reactive terminal functions X′, and
a2) at least one chain extender Y-A′-Y,
wherein X′ is CO₂H and Y is chosen among an epoxy and an oxazoline.

Advantageously, X′ is CO₂H and Y-A′-Y is chosen among phenylene bisoxazolines, preferably 1,3-phenylene-bis(2-oxazoline) or 1,4-phenylene-bis(2-oxazoline) (PBO).

In an advantageous embodiment, the present invention relates to a composition such as defined above, characterized in that it comprises al) at least one amine prepolymer (carrying —NH₂) of said thermoplastic polymer for the matrix, in particular with at least 50% and more particularly with 100% of the terminal groups of said prepolymer al) being primary amine functions —NH₂ and a2) at least one non-polymeric chain extender carrying a cyclic carboxylic anhydride, preferably carried by an aromatic ring, having as a substituent a group comprising an ethylenic or acetylenic unsaturation, preferably acetylenic, where said carboxylic anhydride group can be an acid, ester, amide or imide form with said extender a2) being present at a level corresponding to an a2)/(-NH₂) molar ratio less than 0.36, preferably ranging from 0.1 to 0.35, more preferably ranging from 0.15 to 0.35 and still more preferably ranging from 0.15 to 0.31 and in that said thermoplastic polymer for the matrix is the product of the polymerization reaction by extending said prepolymer a1) by said extender a2).

By the choice of the components a1) and a2) and their specific molar ratio, said reaction leads to a final thermoplastic polymer which is not cross-linked.

Said prepolymer a1) carries primary amine groups represented by —NH₂. More specifically, it should be noted that the average number of primary amine groups per molecule of prepolymer a1), also called the average functionality in primary amine groups, can vary from 1 to 3 and preferably from 1 to 2. In particular, the functionality of said prepolymer a1) of at least 50% of terminal groups of said prepolymer a1) being primary amine functions —NH₂, means that it is possible that a portion either of carboxyl groups or blocked chain ends without reactive group and in that case, the average functionality in —NH₂ can thus vary from 1 to 3 and preferably from 1 to 2.

The term “thermoplastic” in the case of the present invention means that the polymer resulting from the reaction of the prepolymer a1) and the extender a2) is essentially thermoplastic, which means that it contains less than 15% of the weight thereof, preferably less than 10% of the weight thereof and more preferably less than 5% of the weight thereof and still more preferably 0% of the weight thereof (within 0.5% or within 1%) of cross-linked polymers which are insoluble or unmeltable.

Said extender a2) can be chosen among:

anhydrides and anhydride derivatives in acid, ester, amide, or imide form of ethynyl o-phthalic, methyl ethynyl o-phthalic, phenyl ethynyl o-phthalic, naphthyl ethynyl o-phthalic, 4-(o-phthaloyl ethynyl) o-phthalic or 4-(phenyl ethynyl ketone) o-phthalic, where the latter is also called 4-(phenyl ethynyl) trimellitic,

the acids or esters or amides of the following acids: ethynyl isophthalic, methyl ethynyl isophthalic, phenyl ethynyl isophthalic, naphtyl ethynyl isophthalic, 4-(o-phthaloyl ethynyl) isophthalic, 4-(phenyl ethynyl ketone) isophthalic, ethynyl terephthaic, methyl ethynyl terephthaic, phenyl ethynyl terephthaic, naphtyl ethynyl terephthaic, 4-(o-phthaloyl ethynyl) terephthaic, ethynyl benzoic, methyl ethynyl benzoic, phenyl ethynyl benzoic, naphtyl ethynyl benzoic, 4-(o-phthaloyl ethynyl) benzoic.

Advantageously said extender a2) is chosen among aromatic anhydride compounds, preferably o-phthalic, substituted in position 4 of the aromatic ring by a substituent defined by a R—C≡C—(R″)x group where R is a C1-C2 alkyl or H or aryl, in particular phenyl, or R is the residue of an aromatic carboxylic anhydride, preferably o-phthalic, bound to the acetylenic triple bond by the carbon in position 4 of the aromatic ring and x is equal to 0 or 1 and for x equal to 1, R′ is a carbonyl group.

Advantageously, said extender a2) is chosen among the o-phthalic aromatic anhydrides carrying in position 4 a substituent group chosen among methyl ethynyl, phenyl ethynyl, 4-(o-phthaloyl) ethynyl, phenyl ethynyl ketone also called phenyl ethynyl trimellitic anhydride and preferably carriers in position 4 of a substituent group chosen among methyl ethynyl and phenyl ethynyl ketone.

Advantageously, said extender a2), such as defined above and whatever the structure thereof, has a molecular weight less than or equal to 500, preferably less than or equal to 400.

Advantageously, the level of said extender a2), such as defined above and whatever the structure thereof, in said polyamide polymer varies from 1 to 20%, in particular from 5 to 20%.

In an advantageous embodiment, the present invention relates to a composition as defined above, characterized in that it involves a molding composition.

According to another aspect, the present invention relates to a production method for a thermoplastic material, in particular a mechanical part or a structural part based on said material, with composition such as defined above, characterized in that it comprises at least one step of polymerization of at least one reactive composition a) such as defined above according to the invention or a step of molding or of implementation of at least one non-reactive composition b) such as defined above, by extrusion, injection or molding.

In an advantageous embodiment, the present invention relates to a production method for a thermoplastic material such as defined above characterized in that it comprises the following steps:
i) injection into an open or closed mold or without mold of a composition such as defined above, optionally without fibrous reinforcing,
ii) polymerization reaction in the case of a reactive polyamide composition a) such as defined above, by heating of said composition from step i) with chain extender, according to the case, by polycondensation reaction or polyaddition reaction, in bulk in the molten state, with optionally in the case of polycondensation, elimination under vacuum of condensation products when it involves a closed mold, using an extraction system under vacuum, otherwise and preferably with the polycondensation being done in open mold or without mold,
iii) implementation or molding of said composition from step i) in the case of a non-reactive polyamide composition b) for forming the final part in a mold or with another system for implementation and, in the case of a reactive composition a), a step of implementation by molding or by another system for implementation and simultaneously with step ii) of polymerization.

According to another aspect, the present invention relates to a semi-crystalline polyamide polymer, characterized in that it corresponds to (or is the) polymer from the thermoplastic matrix of said thermoplastic material such as defined above, where said polymer is a non-reactive polymer such as defined according to said composition b) or a polymer which could be obtained from a reactive composition such as defined according to said composition a).

This thermoplastic polymer is by definition one of the essential components of the composition of the thermoplastic material from the present invention and therefore is part of the invention as product related to the present invention with the same inventive concept shared in the face of the same technical problem to be resolved. The invention therefore also covers the use of said thermoplastic polymer according to the invention as thermoplastic matrix for a thermoplastic material based on fibrous reinforcing as described above.

According to another aspect, the present invention relates to the use of a composition such as defined above or a non-reactive polymer such as defined according to said composition b) or a polymer which could be obtained from a reactive composition such as defined according to said composition a), for the production of mechanical or structural parts based on said thermoplastic material, single or multilayer pipe, or film.

In an advantageous embodiment, the present invention relates to the use such as defined above, characterized in that said mechanical or structural parts of said thermoplastic material relate to applications in the domain of automotive, rail, marine (maritime), wind, photovoltaic, or solar power including solar panels and components for solar plants, sports, aeronautics and space, road transport (relating to trucks), construction, civil engineering, signs and hobbies.

In another advantageous embodiment, the present invention relates to the use such as defined above, characterized in that said mechanical parts for applications in the automobile field are under the engine hood for the transport of fluid, in particular in devices for air intake, cooling (for example by air, cooling fluid, etc.), transport or transfer of fuel or fluids, especially oil, water, etc.

In again another advantageous embodiment, the present invention relates to the use such as defined above, characterized in that said mechanical or structural parts for applications in electrical or electronic fields are electrical or electronic equipment goods such as encapsulated solenoids, pumps, telephones, computers, printers, fax machines, modems, monitors, remote controls, cameras, circuit breakers, electric cable ducts, optical fibers, switches and multimedia systems.

### Methods for Determination of the Cited Characteristics

The intrinsic or inherent viscosity is measured in m-cresol. The method is well known to the person skilled in the art. The ISO 307:2007 standard is followed but changing the solvent (use m-cresol instead of sulfuric acid and the temperature is 20° C.).
The glass transition temperature Tg is measured using a differential scanning calorimeter (DSC), after a second heating pass, according to the ISO 11357-2:2013 standard. The heating and cooling rates are 20° C./min.
The melting temperature Tm and the crystallization temperature Tc are measured by DSC, according to the ISO 11357-3:2013 standard. The heating and cooling rates are 20° C./min.
The crystallization enthalpy of said polymer matrix is measured using differential scanning calorimetry (DSC) according to the ISO 11357-3:2013 standard.

### EXAMPLES

A—Preparation of a Polyamicie Polymer by Direct Route (without Chain Extension)

The procedure that follows is an example of a preparation process, and is not limiting. It is representative of all the compositions according to the invention:

To a 14 liter autoclave reactor, 5 kg of the following raw materials are added:
500 g water,
the diamines,
the amino acid (optionally),
terephthalic acid and optionally one or the other of the diacids,
the monofunctional chain regulator: benzoic acid in a suitable quantity for the target Mn and varying (benzoic acid) from 50 to 100 g,
35 g of sodium hypophosphite in solution,
0.1 g of a WACKER AK1000 antifoam agent (from Wacker Silicones).

The nature and molar ratios of the molecular motifs and structures of the polyamides (per test, referenced) are given in Table III below.

The closed reactor is purged of its residual oxygen then heated to a temperature of 230° C. relative to the material added. After 30 minutes of stirring in these conditions, the vapor that formed under pressure in the reactor is relaxed progressively over 60 minutes, while progressively increasing the material temperature so as to establish it at Tm+10° C. at atmospheric pressure.

The polymerization is then continued under a 20 L/hour nitrogen blanket until a viscous polymer is obtained.

The polymer is then emptied through the bottom valve then cooled in a water bath then shaped into granules.

The results are shown in Tables III and IV below. These were obtained starting from 1,3-BAC having a cis/trans ratio of 75/25 mol %.

TABLE III

| | 10T | BACT | Tm | Tc | Tm − Tc | DeltaHc | Tg |
|---|---|---|---|---|---|---|---|
| Ref | mol % | mol % | ° C. | ° C. | ° C. | J/g | ° C. |
| C | 100.0 | 0.0 | 314 | 279 | 35 | 63 | 120 |
| 10T* | | | | | | | |
| I1 | 16.7 | 83.3 | 314.9 | 291.2 | 23.7 | 58.3 | 176.1 |
| C | 0.0 | 100.0 | 349 | — | — | — | 187 |
| BACT* | | | | | | | |

C indicates Comparative
I indicates Invention
*Per JP2015017177

The results from Table III show that for a molar fraction of BACT from over 70% to 99.1 mol %, the melting temperature is included from 290° C. to 340° C.

At the same time, the Tg is very high and can be modulated from 155° C. (not shown in the table) to about 190° C.

TABLE IV

| | | Molecular | | | Tm − | | | |
|---|---|---|---|---|---|---|---|---|
| | | structure/Molar | Tm | Tc | Tc | DeltaHc | Tg | Inherent |
| Reference | Test type | composition | ° C. | ° C. | ° C. | J/g | ° C. | viscosity |
| C1 | Comparative | 10T/6T (59/41) | 281 | 236 | 45 | 44 | 122 | 1.12 |
| | (EP1,988,113) | | | | | | | |
| C2 | Comparative | 10T/6T/11 (60/24/16) | 269 | 220 | 49 | 39 | 111 | 1.25 |
| | (EP1,988,113) | | | | | | | |
| C3 | Comparative | 10T/TMDT (59/41) | 263 | 197 | 66 | 35 | 133 | 1.15 |
| | (WO2011/00393) | | | | | | | |
| C10T | Comparative | 10T (100) | 314 | 279 | 35 | 63 | 120 | insoluble |
| C4 | Comparative | 10T/11 (67/33) | 269 | 232 | 37 | 50 | 84 | 1.19 |
| C5 | Comparative | 10,T/11 (59/41) | 261 | 213 | 48 | 39 | 78 | 1.15 |
| C6 | Comparative | 10T/10I (67/33) | 269 | 205 | 64 | 32 | 110 | 1.12 |
| C7 | Comparative | MXDT/11 (59/41) | 211 | (*) | >100 | 12 | 111 | 1.25 |
| C8 | Comparative | MPMDT/11 (59/41) | — | (*) | — | — | 84 | 1.14 |
| C9 | Comparative | 10T/MXDT (50/50) | 262 | 211 | 51 | 17 | 137 | 0.99 |
| C10 | Comparative | 10T/MPMDT (59/41) | 264 | 219 | 45 | 40 | 126 | 1.11 |
| C11 | Comparative | 10T/MPMDT (50/50) | 245 | 185 | 60 | 22 | 127 | 1.12 |
| C12 | Comparative | 10T/12T/11 (60/24/16) | 271 | 246 | 25 | 56 | 105 | 0.98 |
| C13 | Comparative | 18T/MXDT (71/29) | 264 | 242 | 22 | 47 | 95 | 0.86 |
| C14 | Comparative | 1,3BACT/10T (60/40) | 275.6 | 241.7 | 33.9 | 60.8 | 134.0 | 0.92 |
| C15 | Comparative | 1,3BACT/10T (60/40) | 281.7 | 248.3 | 33.4 | 53.5 | 153.4 | 1.05 |
| C16 | Comparative | 1,3BACT/10T (45/55) | 279.4 | 242.5 | 36.9 | 55.5 | 146.0 | 0.93 |
| C17 | Comparative | 1,3BACT/10T (45/55) | 279.8 | 252.0 | 27.8 | 62.2 | 142.7 | 0.87 |
| C18 | Comparative | 1,3BACT/10T (40/60) | 282.0 | 253.5 | 28.5 | 49.7 | 160.2 | 1.09 |
| C19 | Comparative | 1,3BACT/10T (40/60) | 286.1 | 250.4 | 35.7 | 57.0 | 163.9 | 0.94 |

(*): No crystallization on cooling.

The results from Table IV show that the total substitution of the BAC or of the 10T motif or a portion of 10T greater than or equal to 30% leads to compositions not having at least one of the required values of Tm, Tg, Tm−Tc and delta Hc.

1. A composition for a thermoplastic material comprising:
0 to 70% by weight of short reinforcing fibers,
30 to 100% by weight of a thermoplastic matrix based on at least one semi-crystalline polyamide polymer,
0 to 50% of additives and/or other polymers,
where said composition is:
a) a reactive composition comprising at least one reactive polyamide prepolymer precursor of said semi-crystalline polyamide polymer,
or in alternative to a),
b) a non-reactive composition of at least one polyamide polymer where said composition is that of said thermoplastic matrix defined above,
and said reactive polyamide prepolymer for the composition a) and said polyamide polymer for the composition b) comprising at least one BACT/XT copolyamide in which:
BACT is a unit with an amide motif present at a molar content ranging from 70 to 99.1% where BAC is selected from the group consisting of 1,3-bis(aminomethypcyclohexyl (1,3-BAC), 1,4-bis(aminomethypcyclohexyl (1,4-BAC) and a mixture thereof, and T is terephthalic acid,
XT is a unit with an amide motif present at a molar content ranging from 0.9 to 30% where X is a C₉ to C₁₈ linear aliphatic diamine, and where T is terephthalic acid,
in the BACT and/or XT units, independently of each other, up to 30 mol %, of terephthalic acid, relative to the total quantity of dicarboxylic acids, can be replaced by other aromatic, aliphatic or cycloaliphatic dicarboxylic acids comprising 6 to 36 carbon atoms, and
in the BACT and/or XT units, independently of each other, up to 30 mol % of BAC and/or if applicable X, relative to the total quantity of the diamines, can be replaced by other diamines comprising from 4 to 36 carbon atoms, and in the copolyamide, not more than 30 mol % relative to the total quantity of the monomers, can be formed by lactams or aminocarboxylic acids, and
provided that the sum of the monomers that replace terephthalic acid, BAC and X does not exceed a concentration of 30 mol %, relative to the total quantity of the monomers used in the copolyamide, and provided that BACT and XT units are still present in said polyamide polymer.

2. The composition according to claim 1, wherein said semi-crystalline polyamide polymer has a melting temperature Tm of from 290° C. to 340° C., as determined according to the ISO 11357-3 (2013) standard.

3. The composition according to claim 1, wherein said semi-crystalline polyamide polymer has a glass transition temperature Tg>150° C., determined according to the ISO 11357-2:2013 standard,

4. The composition according to claim 1, wherein said semi-crystalline polyamide polymer has a difference between the melting temperature and the crystallization temperature Tm−Tc<40° C., determined according to the ISO 11357-3:2013 standard.

5. The composition according to claim 1, that wherein the enthalpy of crystallization of the semi-crystalline polyamide polymer, measured by differential scanning calorimetry (DSC) according to the ISO 11357-3:2013 standard, is greater than 40 J/g.

6. The composition according to claim 1, wherein BAC is 1,3-BAC.

7. The composition according to claim 1, wherein the BAC is 1,3-BAC and XT is chosen from 9T, 10T, 11T and 12T.

8. The composition according to claim 1, wherein the XT is 10T, 10 corresponding to 1,10-decanediamine.

9. The composition according to claim 1, wherein the sum of the monomers that replace terephthalic acid, BAC and X is equal to 0.

10. The composition according to claim 1, wherein said composition is a non-reactive composition according to b).

11. The composition according to claim 1, wherein said polyamide composition is a reactive prepolymer composition according to a) and precursor of said polyamide polymer of said thermoplastic material matrix.

12. The composition according to claim 1, wherein said composition further comprises at least one additive.

13. The composition according to claim 12, wherein the additive is selected from the group consisting of an antioxidant, a thermal stabilizer, a UV absorber, a light stabilizer, an impact modifier, a lubricant, an inorganic filler, a flame retardant agent, a nucleating agent and a colorant.

14. The composition according to claim 1, wherein said composition is a molding composition.

15. A production method for a thermoplastic mechanical part or a structural part made from the composition defined according to claim 1, wherein said method comprises at least one step of polymerization of at least one reactive composition a) or a step of molding or of implementation of at least one non-reactive composition b) by extrusion, injection molding.

16. The method according to claim 15, wherein said method comprises the following steps:
injecting into an open or closed mold or without a mold, composition according to claim 1, optionally without fibrous reinforcing,
ii) polymerizing in the case of a reactive polyamide composition a) by heating of said composition from step i) with chain extender, by a polycondensation reaction or polyaddition reaction, in bulk in the molten state, with optionally in the case of polycondensation, elimination under vacuum of condensation products when it involves a closed mold, using an extraction system under vacuum,
iii) molding of said composition from step i) in the case of a non-reactive polyamide composition b) for forming a final part in a mold and, in the case of a reactive composition a), a step of molding and simultaneously with step ii) of polymerization.

17. A semi-crystalline polyamide polymer, wherein it corresponds to (or is the) polymer from the thermoplastic matrix of said thermoplastic material such as defined according to claim 1, where said polymer is a non-reactive polymer such as defined according to said composition b) or a polymer which could be obtained from a reactive composition such as defined according to said composition a).

18. (canceled)

19. The mechanical or structureal part of claim 23, wherein said mechanical or structural part is a material in a automotive, electrical or electronics, rail, marine, wind power, photovoltaic, solar solar panels and components for solar plants, sports, aeronautics and space, road transport, construction, civil engineering, signs and leisure application.

20. (canceled)

21. (canceled)

22. (canceled)

23. A mechanical or structural part made of said thermoplastic material, of claim 1.

24. The part according to claim 23, wherein said part is a mechanical part in the automobile field selected from the group consisting of parts under the engine hood for the transport of fluid, devices for air intake, devices for cooling of fluids, devices for the cooling of air, transport or transfer of fuel, transport or transfer of oil, and the transport or transfer of water.

25. The part according to claim 23, wherein said part is a mechanical or structural part in the electrical or electronic fields selected from the group consisting of electrical or electronic equipment goods, encapsulated solenoids, pumps, telephones, computers, printers, fax machines, modems, monitors, remote controls, cameras, circuit breakers, electric cable ducts, optical fibers, switches and multimedia systems.
